(19) United States
(12) Patent Application Publication
(10) Pub. No.: US 2019/0036436 A1
(43) Pub. Date: Jan. 31, 2019

(54) ELECTROMAGNETIC ENERGY CONVERTER

(71) Applicant: COMMISSARIAT A L'ENERGIE ATOMIQUE ET AUX ENERGIES ALTERNATIVES, Paris (FR)

(72) Inventors: Ghislain DESPESSE, Voreppe (FR); Sebastien BOISSEAU, Echirolles (FR)

(73) Assignee: COMMISSARIAT A L'ENERGIE ATOMIQUE ET AUX ENERGIES ALTERNATIVES, Paris (FR)

(21) Appl. No.: 16/041,142

(22) Filed: Jul. 20, 2018

(30) Foreign Application Priority Data
Jul. 25, 2017 (FR) 17 57054

(51) Int. Cl. H02K 35/06

(52) U.S. Cl. CPC H02K 35/06; H01H 50/36

(57) ABSTRACT

The invention relates to an electromagnetic energy converter which comprises at least one magnetic circuit capable of inducing a variation in the magnetic flux through a conductive coil (200). In this respect, the magnetic circuit comprises a yoke (300) laid out to pivot around an axis of rotation between a first P1 and a second P2 equilibrium position stabilised, respectively, by a first fixed magnet and a second fixed magnet.

Also, the two magnets are laid out such that the stabilisation of the yoke (300) according to one or the other of the first P1 and second P2 equilibrium positions enable the circulation of a magnetic flux in the conductive coil (200), respectively, along a first direction and a second direction opposite to the first direction.

### TECHNICAL FIELD

The present invention relates to an electromagnetic energy converter. In particular, the present invention relates to an electromagnetic converter intended to be implemented in an autonomous switch.

### Prior Art

FIG. 1 represents an electromagnetic energy converter known from the prior art and described in the document [1] cited at the end of the description.

This electromagnetic energy converter comprises two distinct magnetic circuits 10 and 20 passing through a conductive coil 30 along its elongation axis XX′.

In particular, each magnetic circuit 10 and 20 comprises a permanent magnet 11, 21 inserted in the air gap of a ferromagnetic yoke 13, 23 intended to guide a magnetic flux generated by the permanent magnet 11, 21 through the conductive coil 30. The two permanent magnets 11, 21 are further laid out such that the magnetic fluxes guided by the two yokes through the coil are opposite to each other.

The general operating principal of the electromagnetic energy converter is based on the activation of a temporal variation in the magnetic flux passing through the conductive coil so as to make an electrical voltage appear at the terminals of the latter.

In this respect, the electromagnetic energy converter is also provided with a mechanical activation system, the action of which makes it possible to activate the temporal variation in magnetic flux. In particular, the activation system comprises two ferromagnetic parts 40 and 50, moveable, intended to short-circuit, and in a differentiated manner, one or the other of the two magnetic circuits 10 and 20.

However, this electromagnetic energy converter described in the document [1] is not satisfactory.

Indeed, each ferromagnetic part 40 or 50 only short-circuits partially one or the other of the magnetic circuits 10 and 20, limiting de facto the temporal variation in magnetic flux through the conductive coil 30.

Furthermore, the effect of saturation and magnetic losses of the magnetic circuits makes the use of permanent magnets having a greater magnetization futile.

Moreover, the mechanical activation system necessitates the use of an energy escape and/or accumulation module, such as spring clips, or instead pawls, enabling a rapid movement of the ferromagnetic parts 40 and 50 so that an appreciable voltage can be reached at the terminals of the conductive coil.

As an example, a displacement of a duration of the order of a millisecond is necessary for a converter, having a volume of the order of 1 cm³, to generate an electrical voltage of the order of a Volt at the terminals of the conductive coil. A voltage of this order of magnitude is notably required as soon as the electromagnetic energy converter is implemented in autonomous switches.

However, the escape and/or accumulation of energy module, as soon as it requires the addition of additional elements, makes the implementation of the converter complicated, and accordingly affects its robustness.

One aim of the present invention is then to propose a compact electromagnetic energy converter, and capable of having an appreciable electrical voltage at the terminals of the conductive coil for a reduced volume.

Another aim of the present invention is to propose an electromagnetic energy converter that is simpler to implement.

### DESCRIPTION OF THE INVENTION

The aforementioned aims are, at least in part, attained by an electromagnetic energy converter comprising:
a conductive coil extending along an elongation axis XX′,
at least one magnetic flux variation device which comprises a yoke and two fixed magnets called, respectively, first magnet and second magnet, the yoke comprising a main section passing through the conductive coil, and a secondary portion offset from the conductive coil, the yoke being laid out to pivot around a fixed axis of rotation, parallel to the elongation axis XX′, between two stable equilibrium positions called, respectively, first equilibrium position P1 and second equilibrium position P2, the two magnets being laid out such that when the yoke is in its first equilibrium position P1, said yoke is magnetically coupled to the first magnet so as to make a magnetic flux circulate through the conductive coil in a first direction S1, and when the yoke is in its second equilibrium position P2, said yoke is magnetically coupled to the second magnet so as to make a magnetic flux circulate through the conductive coil in a second direction S2 opposite to the first direction S1.

According to one embodiment, the secondary portion of the yoke comprises an air gap at the level of which takes place the magnetic coupling of one or the other of the first and second magnets with said yoke as soon as the latter finds itself, respectively, in its first equilibrium position P1 or in its second equilibrium position P2.

According to one embodiment, as soon as the yoke is magnetically coupled to one or the other of the two magnets, said magnet is either inserted in the air gap, or bearing against the yoke and straddles the air gap.

It should be noted that the magnet may be a material magnetized in a permanent manner, for example neodymium-iron-boron, or this same material accompanied by ferromagnetic parts to better channel the magnetic flux when placed in contact.

According to one embodiment, the secondary portion comprises a straight secondary section, parallel to the elongation axis XX′, and at the level of which is arranged the air gap.

According to one embodiment, the secondary portion of the yoke comprises a first air gap and a second air gap at the level of which takes place the magnetic coupling, respectively, of the first magnet and of the second magnet with said yoke as soon as the latter finds itself, respectively, in its first equilibrium position P1 or in its second equilibrium position P2.

The first and the second magnet duplicated (cut) into two parts, which face the first and second air gaps, may furthermore be considered. In other words, two magnets may be facing each of the air gaps (presence of four magnets).

According to one embodiment, the converter further comprises a first element and a second element, fixed, made of a ferromagnetic material, and laid out to short-circuit, respectively, the first air gap and the second air gap as soon as the yoke finds itself, respectively, in its second equilibrium position P2 or in its first equilibrium position P1.

According to one embodiment, the secondary portion comprises a secondary section, parallel to the elongation axis XX′, at the level of which are arranged the first air gap and the second air gap.

According to one embodiment, the converter comprises, moreover, a first short-circuit and a second short-circuit, integral with the yoke, and intended to short-circuit the field lines, respectively, of the first magnet and of the second magnet as soon as the yoke finds itself in the second equilibrium position P2 or in the first equilibrium position P1.

According to one embodiment, the first short-circuit and the second short-circuit each comprise a ferromagnetic plate laid out to connect the two poles, respectively, of the first magnet and of the second magnet, as soon as the yoke finds itself in the second equilibrium position P2 or in the first equilibrium position P1.

According to one embodiment, the first magnet and the second magnet have, respectively, a first magnetic polarity and a second magnetic polarity, the first and the second magnetic polarity being parallel and in opposition to each other, advantageously, the first magnetic polarity is parallel to the elongation axis XX′.

According to one embodiment, the converter further comprises at least one side tongue laid out to cause the passage of the yoke from its first equilibrium position P1 to its second equilibrium position as soon as an external force is applied to said tongue.

According to one embodiment, the side tongue is adapted to bend under the action of an external force and to accumulate a mechanical energy before the yoke passes from its first equilibrium position P1 to its second equilibrium position P2, said mechanical energy accumulated by the side tongue is released during the passage of the yoke from its first equilibrium position P1 to its second P2 equilibrium position.

According to one embodiment, the converter is also provided with a return means adapted to force the yoke to adopt the first equilibrium position P1 as soon as no external force is applied to said yoke.

According to one embodiment, the at least one magnetic flux variation device comprises two magnetic flux variation devices called, respectively, first magnetic flux variation device and second magnetic flux variation device, the yokes of each of the first magnetic flux variation device and second magnetic flux variation device called, respectively, first yoke and second yoke are laid out to pivot in a simultaneous and symmetrical manner, one from the other, with respect to a plane passing through the elongation axis XX′, around their respective axes of rotation, as soon as an external force is exerted on one or the other of the two yokes.

According to one embodiment, the main sections of the first yoke and second yoke called, respectively, first main section and second main section, cooperate with each other, via cooperation means, so as to enable said yokes to pivot in a simultaneous manner around their respective axes of rotation as soon as an external force is exerted on one or the other of the two yokes.

According to one embodiment, the cooperation means comprise a gearing formed on each of the first and second main sections.

According to one embodiment, the cooperation means comprise a groove formed on one of the first or second main sections, and a profile formed on the other of the first or second main sections, the profile being lodged in the groove.

The invention also relates to an autonomous switch comprising the electromagnetic energy converter according to the present invention.

The aforementioned aims are, at least in part, attained by an electromagnetic energy converter comprising:
a conductive coil extending along an elongation axis XX′,
at least one magnetic flux variation device which comprises a yoke provided with a main section passing through the conductive coil, and a secondary portion provided with an air gap and offset from the conductive coil, the yoke being laid out to pivot around a fixed axis of rotation, parallel to the elongation axis XX′, between two stable equilibrium positions called, respectively, first equilibrium position P1 and second equilibrium position P2, said yoke being intended to guide a magnetic flux generated by a magnet lodged in the air gap, said magnet is laid out to pivot around a pivot axis between two pivot positions called, respectively, first pivot position and second pivot position, the at least one magnetic flux variation device further comprises a drive mechanism laid out to force the magnet to adopt the first pivot position or the second pivot position as soon as the yoke finds itself, respectively, in the first position P1 or the second position P2, and such that when the yoke is in its first position P1, the magnetic flux is guided by said yoke through the conductive coil in a first direction S1, and when the yoke is in its second equilibrium position P2, the magnetic flux is guided by said yoke through the conductive coil in a second direction S2 opposite to the first direction S1.

According to one embodiment, the drive mechanism comprises a fixed rack, cooperating with a gearing integral with the magnet.

According to one embodiment, the drive mechanism comprises a leg fixedly maintained, along one of its ends, to the yoke at the level of the air gap, and intended to make the magnet pivot from one of its pivot positions to the other of its pivot positions as soon as the yoke pivots from one of the equilibrium positions to the other of its equilibrium positions, advantageously the leg comprises another end connected to the magnet by a pivot link, said pivot link being offset from the pivot axis.

According to one embodiment, the magnet has a symmetry of revolution around the pivot axis, advantageously, the air gap has a shape complementary to the magnet.

According to one embodiment, the magnet has a parallelepiped shape.

According to one embodiment, the magnet comprises two ends in alignment with the direction defined by its poles, and at the level of which are arranged a first and a second ferromagnetic plate and intended to prevent any contact between the yoke and the magnet.

According to one embodiment, the secondary portion comprises a straight secondary section, parallel to the elongation axis XX′, and at the level of which is arranged the air gap.

According to one embodiment, the converter further comprises at least one side tongue laid out to cause the passage of the yoke from its first equilibrium position P1 to its second equilibrium position as soon as an external force is applied to said tongue.

According to one embodiment, the side tongue is adapted to bend under the action of an external force and to accumulate a mechanical energy before the yoke passes from its first equilibrium position P1 to its second equilibrium position P2, said mechanical energy accumulated by the side tongue is released during the passage of the yoke from its first equilibrium position P1 to its second P2 equilibrium position.

According to one embodiment, the converter is also provided with a return means adapted to force the yoke to adopt the first equilibrium position P1 as soon as no external force is applied to said yoke.

According to one embodiment, the at least one magnetic flux variation device comprises two magnetic flux variation devices called, respectively, first magnetic flux variation device and second magnetic flux variation device, the yokes of each of the first magnetic flux variation device and second magnetic flux variation device called, respectively, first yoke and second yoke, are laid out to pivot in a simultaneous and symmetrical manner, one from the other, with respect to a plane passing through the elongation axis XX′, around their respective axes of rotation, as soon as an external force is exerted on one or the other of the two yokes.

According to one embodiment, the main sections of the first yoke and second yoke called, respectively, first main section and second main section, cooperate with each other, via cooperation means, so as to enable said yokes to pivot in a simultaneous manner around their respective axes of rotation as soon as an external force is exerted on one or the other of the two yokes.

According to one embodiment, the cooperation means may comprise a gearing formed on each of the first and second main sections.

According to one embodiment, the cooperation means comprise a groove formed on one of the first or second main sections, and a profile formed on the other of the first or second main sections, the profile being lodged in the groove.

The invention also relates to an autonomous switch comprising the electromagnetic energy converter according to the present invention.

### BRIEF DESCRIPTION OF THE DRAWINGS

Other characteristics and advantages will become clear from the description that follows of the electromagnetic energy converter according to the invention, given by way of non-limiting examples, with reference to the appended drawings in which:

FIG. 1 is a schematic representation in perspective of an electromagnetic energy converter known from the prior art;

FIG. 2 is a schematic representation, along a cut plane passing through the elongation axis XX′ and parallel to a plane formed by the support, of the electromagnetic energy converter according to a first embodiment of the present invention;

FIGS. 3a, 3b and 3c are schematic representations, along a cut plane perpendicular to the elongation axis XX′, of the electromagnetic energy converter according to the first embodiment of the present invention, in particular, FIGS. 3a, 3b, and 3c represent, respectively, the yoke in its first equilibrium position, in a median position, and in its second equilibrium position;

FIG. 4a is a schematic representation of the magnetic coupling of the yoke with a magnet according to a first example of a first alternative of the first embodiment of the present invention;

FIG. 4b is a schematic representation of the arrangement of the first and second short-circuits according to the first example of the first alternative of the first embodiment of the present invention;

FIG. 4c is a schematic representation of the magnetic coupling of the yoke with a magnet according to a second example of the first alternative of the first embodiment of the present invention;

FIG. 5 is a schematic representation of the arrangement of the first and second air gaps with respect to two permanent magnets according to a second alternative of the first embodiment of the present invention,

FIG. 6 is a schematic representation, along a cut plane passing through the elongation axis XX′ and parallel to a plane formed by the support, of the electromagnetic energy converter according to a second embodiment of the present invention;

FIGS. 7a, 7b and 7c are schematic representations, along a cut plane perpendicular to the elongation axis XX′, of the electromagnetic energy converter according to the second embodiment of the present invention, in particular, FIGS. 7a, 7b, and 7c representing, respectively, the first and the second yokes in their first equilibrium position, in a median position, and in their second equilibrium position;

FIGS. 8a, 8b and 8c are schematic representations, along a cut plane perpendicular to the elongation axis XX′, of the cooperation means according to the second embodiment of the present invention;

FIGS. 9a, 9b and 9c are schematic representations, along a cut plane perpendicular to the elongation axis XX′, of a pivot link between the first main section and the second main section according to the second embodiment of the present invention;

FIGS. 10a and 10b are schematic representations, along a cut plane comprising the elongation axis XX′, and along a cut plane perpendicular to the elongation axis XX′, respectively;

FIGS. 11a, 11b, 11c and 11d are schematic representations of the arrangement of the magnet in the air gap of the yoke according to the third and fourth embodiments of the present invention, in particular, FIGS. 11a, 11b, 11c and 11d propose examples of drive mechanisms;

FIGS. 12, 13 and 14 are schematic representations of dismountable yokes capable of being implemented in the different embodiments of the present invention;

FIG. 15 is a schematic representation of a support provided with an upright intended to maintain at least one ferromagnetic yoke;

FIGS. 16a and 16b are schematic representations of a fifth embodiment, in particular, these two figures represent a mode of coupling the magnet with the ferromagnetic yoke, said magnet being arranged in the air gap of said yoke.

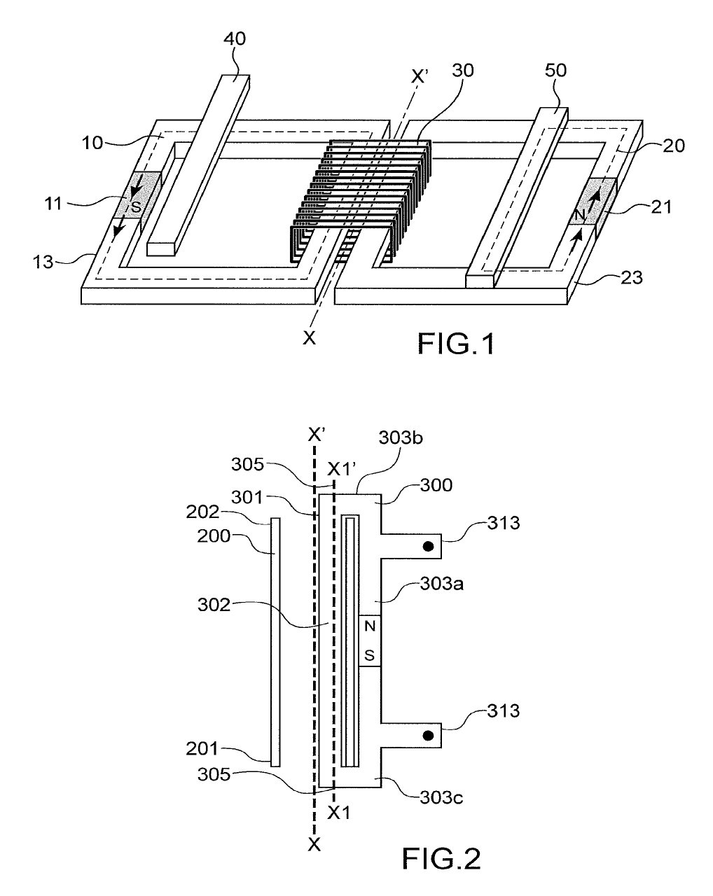

### DETAILED DESCRIPTION OF PARTICULAR EMBODIMENTS

The invention described in a detailed manner below implements an electromagnetic energy converter which comprises at least one magnetic circuit capable of inducing a variation in the magnetic flux passing through a conductive coil.

In this respect, the magnetic circuit comprises a yoke laid out to pivot around an axis of rotation between a first P1 and a second P2 equilibrium position stabilised, respectively, by a first fixed magnet and a second fixed magnet.

According to the present invention, the two magnets are laid out such that the stabilisation of the yoke according to one or the other of the first P1 and second P2 equilibrium positions enables the circulation of a magnetic flux in the conductive coil, respectively, along a first direction and a second direction opposite to the first direction.

Thus, according to this layout, the passage from one of the first P1 or second equilibrium positions P2 to the other equilibrium position, for example by exerting a force on the yoke, is accompanied by a temporal variation in the magnetic flux passing through the conductive coil and thus the appearance of a voltage at the terminals of said conductive coil.

In FIGS. 2, 3a, 3b, 3c, 4a, 4b, 4c and 5 may be seen an electromagnetic energy converter 100 according to a first embodiment of the present invention.

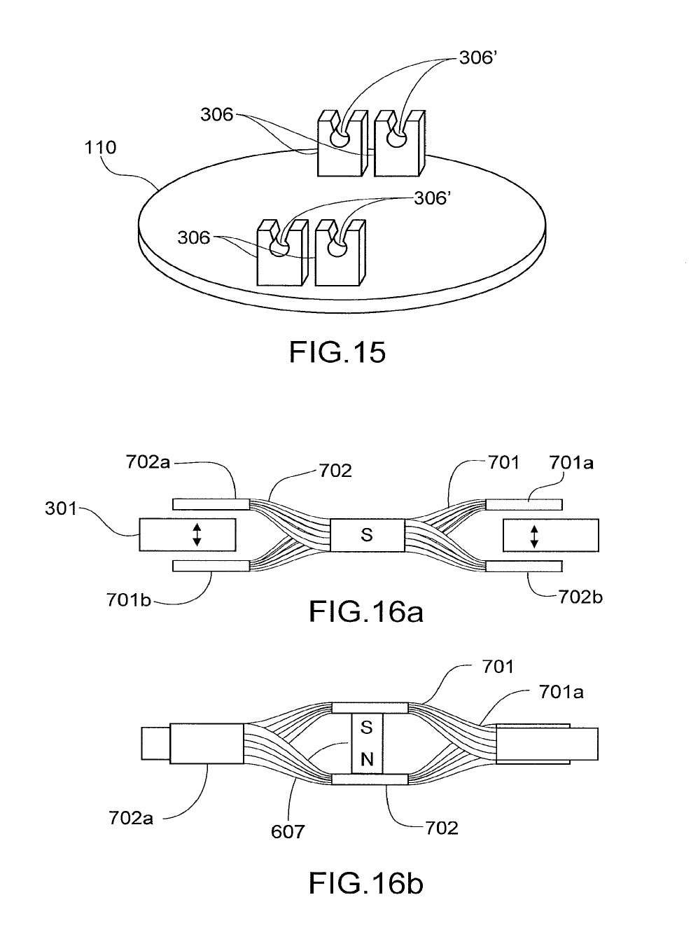

The electromagnetic energy converter 100 comprises a support 110, for example a plate of rectangular or circular shape and made of a plastic material (FIG. 15).

Furthermore, it is understood that, throughout the description, as soon as an element or an axis of the converter 100 are considered as fixed, they are maintained to the support 110 by a fixed connected (or embedding). In other words, the mention of the support 110 could be omitted as soon as an element or axis of the converter 100 is considered as fixed.

The electromagnetic energy converter 100 comprises a conductive coil 200 which extends along an elongation axis XX′ and comprises two ends called, respectively, first end 201 and second end 202 (FIG. 2).

The conductive coil 200 is made of a winding of a conductive wire, for example a copper wire, along the elongation axis XX′. The conductive coil 200 furthermore comprises an internal volume V open along the two ends of said coil. It is understood without it being necessary to specify it that the conductive wire comprises two ends which are, throughout the remainder of the present description, named terminals of the conductive coil 200.

The conductive coil may be fixed with respect to the support 110.

The electromagnetic energy converter 100 further comprises at least one magnetic flux variation device 300.

The magnetic flux variation device 300 comprises a yoke 301.

Yoke is taken to mean an element, one-piece, adapted to guide the field lines created by a magnet to which said yoke is magnetically coupled. In particular, within the meaning of the present invention, the yoke, as soon as it is magnetically coupled with a magnet, forms with said magnet a closed magnetic circuit.

The yoke may comprise at least one ferromagnetic material selected from: iron, alloy of iron and silicon, alloy of iron and nickel, alloy of iron and cobalt.

The yoke 301 comprises a main section 302 passing through the conductive coil 200. In other words, the conductive wire forming the conductive coil is wound around the main section 302. Furthermore, the main section 302 comprises two ends called, respectively, first main end and second main end.

The yoke 301 may be stratified, in other words the yoke may be formed by a stack of ferromagnetic elements.

The main section 302 may be straight, and parallel to the elongation axis XX′.

The yoke 301 also comprises a secondary portion 303 offset from the conductive coil 200.

“Offset” from the conductive coil 200 is taken to mean not passing through said coil.

It is understood, without it being necessary to specify it, that the secondary portion 303 connects the two ends of the main section 302.

The secondary portion 303 may comprise a secondary section 303a and two side sections 303b and 303c, the two side sections, 303b and 303c, connecting the secondary section 303a to the main section 302.

The yoke 301 forms a frame, advantageously a rectangular frame, formed by the main section 302, the two side sections 303b and 303c, as well as the secondary section 303a.

Furthermore, according to this embodiment, the cross-sectional area of the main section 302 may advantageously be identical to the cross-sectional area of the secondary portion 303.

Within the meaning of the present invention, “cross-section” is taken to mean the section resulting from the intersection of a plane perpendicular to the elongation axis of an element.

Moreover, the yoke 301 is laid out to pivot around an axis of rotation X1-X1′ between two stable equilibrium positions, called first equilibrium position P1 and second equilibrium position P2. The axis of rotation X1-X1′ is fixed (with respect to the support 110).

Advantageously, the axis of rotation X1-X1′ passes through the conductive coil 200.

The passage of the yoke 301 from its first equilibrium position P1 to its second P2 equilibrium position is named “direct cycle”.

The passage of the yoke 301 from its second equilibrium position P2 to its first equilibrium position P1 is named “indirect cycle”.

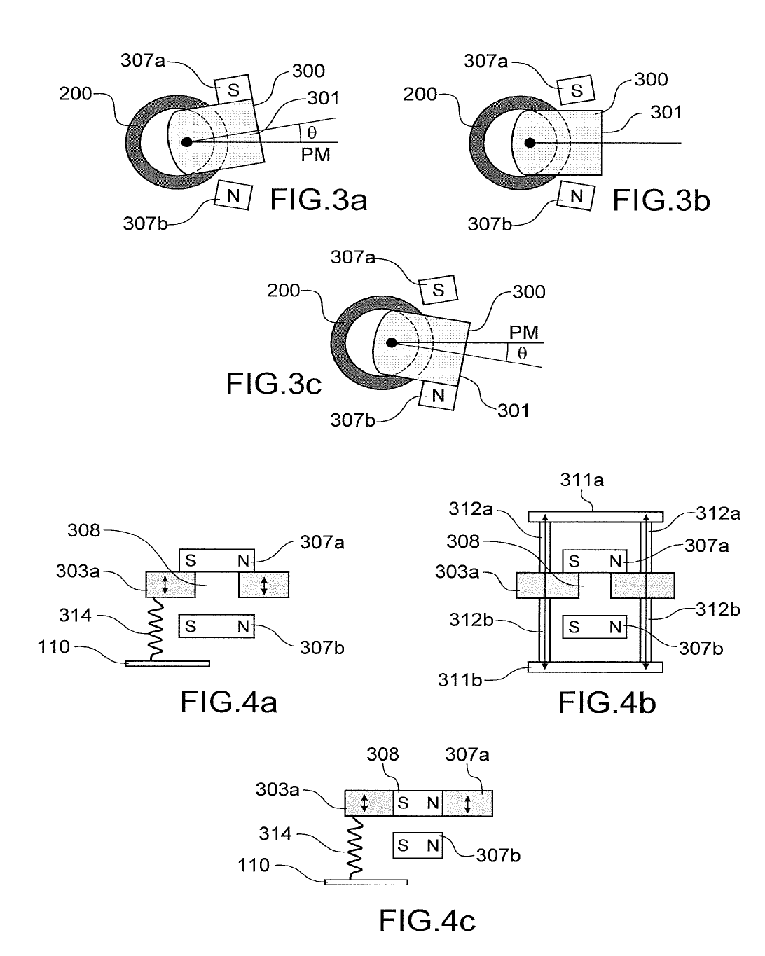

The amplitude of rotation of the yoke 301 around the axis of rotation X1-X1′ is defined by an angular displacement θ with respect to a median plane PM (it is understood without it being necessary to specify it that the median plane PM comprises the axis of rotation X1-X1′). The median plane PM, in terms of angular displacement θ of the yoke 301, is halfway between the first P1 and second P2 positions (FIG. 3b).

In particular, the median plane PM may advantageously be parallel to a mean plane formed by the support 110.

“Laid out to pivot around an axis of rotation X1-X1′” is taken to mean that the yoke 301 is mechanically connected to the support 110 by a pivot link 304.

In particular, the pivot link between the yoke 301 and the support 110 may be implemented by pivot means 304.

For example, the pivot means 304 may comprise two shafts 305 arranged on the yoke 301, co-linear with the axis of rotation X1-X1′, and extending in two opposite directions from the external side surface of said yoke 301. In particular, each shaft 305 may be arranged on one of the two side sections 303b and 303c (FIG. 2).

The pivot means 304 may also comprise two uprights 306 arranged on the support 110, and each provided with a drilling hole 306′ (FIG. 15) intended to cooperate, each, with one of the shafts 305 arranged on the yoke 301 so as to maintain the pivot link between the yoke 301 and the support 110. It is understood that, as soon as the drilling holes 306′ of the two uprights 306 each cooperate with a shaft 305 of the yoke 301, said drilling holes 306′ are on the axis of rotation X1X1′.

The magnetic flux variation device 300 also comprises two fixed magnets called, respectively, first magnet 307a and second magnet 307b.

In particular, the first magnet 307a and the second magnet 307b have, respectively, a first magnetic polarity and a second magnetic polarity.

“Magnetic polarity” is taken to mean the orientation of the poles of the magnet.

In particular, the first magnet 307a is laid out such that when the yoke 301 is in its first equilibrium position P1, said yoke 301 is magnetically coupled to the first magnet 307a so as to make a magnetic flux circulate, said flux passing through the conductive coil 200 in a first direction S1 (FIG. 3a).

Furthermore, the second magnet 307b is laid out such that when the yoke 301 is in its second equilibrium position P2, said yoke 301 is magnetically coupled to the second magnet 307b so as to make a magnetic flux circulate, said flux passing through the conductive coil 200 in a second direction S2 opposite to the first direction S1 (FIG. 3c).

It is understood that when the yoke 301 is in its first stable equilibrium position P1, it is stabilised magnetically by the first magnet 307a.

In an equivalent manner, when the yoke 301 is in its second stable equilibrium position P2, it is stabilised magnetically by the second magnet 307b

In particular, the first magnet 307a and the second magnet 307b are laid out such that the angular displacement θ, between the second position P2 and the first position P1, is comprised in the interval −45°, 45°.

In particular, the first position P1 may correspond to an angular displacement θ of +5°, and the second position P2 may correspond to an angular displacement θ of −5°.

By convention, throughout the description, a positive angle θ corresponds to a coupling of the yoke 301 with the first magnet, and a negative angle θ corresponds to a coupling of the yoke 301 with the second magnet.

According to a first alternative, the secondary portion comprises an air gap 308 at the level of which takes place the magnetic coupling with the first magnet 307a and the second magnet 307b as soon as the yoke 301 finds itself, respectively, in its first equilibrium position P1 or in its second equilibrium position P2.

For example, the air gap 308 may be arranged at the level of the secondary section 303a.

Advantageously, as soon as the yoke 301 is magnetically coupled to one or the other of the two magnets 307a and 307b, said magnet is bearing against the yoke 301 and straddles the air gap 308 (FIG. 4a).

Alternatively, as soon as the yoke 301 is magnetically coupled to one or the other of the two magnets 307a and 307b, said magnet is inserted in the air gap 308 (FIG. 4c).

It is thus understood that, according to this first alternative of this first embodiment, the two magnets 307a and 307b are facing each other through the air gap 308.

Advantageously, the air gap 308 is arranged at the level of the secondary section 303a. In particular, the secondary section 303a is rectilinear and parallel to the elongation axis XX′.

Advantageously, the first magnetic polarity and the second magnetic polarity are parallel to the elongation axis XX′, and in opposition to each other.

This configuration enables a temporal variation in the magnetic flux passing through the conductive coil that is the highest possible.

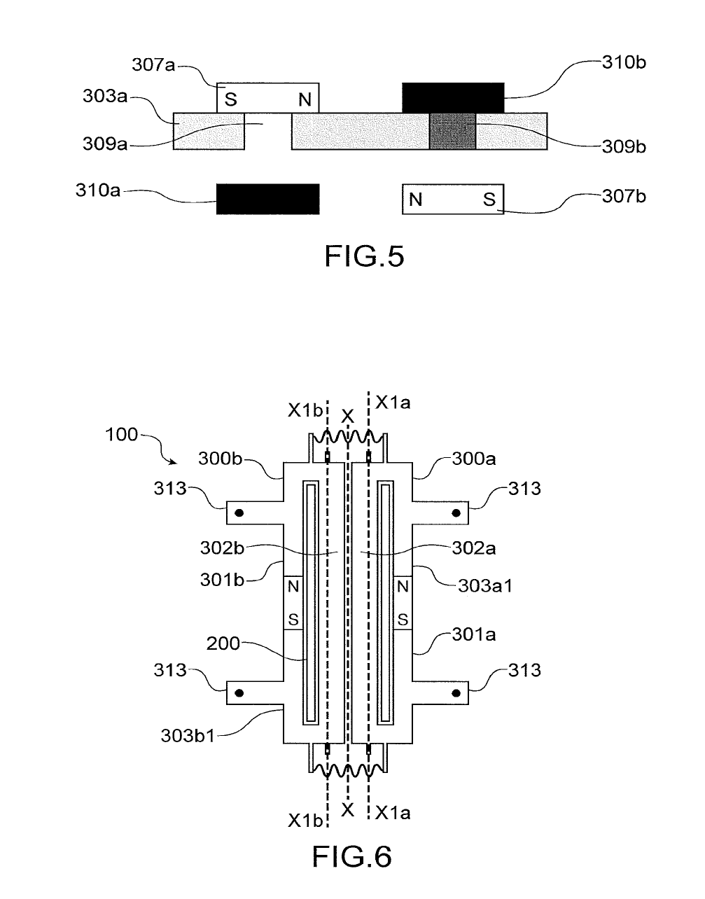

According to a second alternative, the secondary portion comprises a first air gap 309a and a second air gap 309b (FIG. 5) at the level of which takes place the magnetic coupling between the yoke 301 and, respectively, the first magnet 307a and the second magnet 307b.

Advantageously, the volume of at least one of the two air gaps 309a and 309b may be filled with an amagnetic material so as to ensure the mechanical strength of the yoke 301.

The amagnetic material may comprise at least one of the elements selected from: plastic, aluminium, tin, copper, adhesive.

In a particularly advantageous manner, the converter further comprises a first element 310a and a second element 310b, fixed, made of a ferromagnetic material, and laid out to short-circuit, respectively, the first air gap 309a and the second air gap 309b as soon as the yoke finds itself, respectively, in its second equilibrium position P2 or in its first equilibrium position P1.

“Short-circuit an air gap” is taken to mean joining the two ends of the air gap so as to ensure a continuity of the magnetic circuit.

The first element 310a and the second element 310b are for example plates made of a ferromagnetic material. The ferromagnetic material may comprise at least one of the elements selected from: iron, alloy of iron and silicon, alloy of iron and nickel, alloy of iron and cobalt, iron oxide.

For example, when the first air gap 309a is short-circuited by the first element 310a, said element 310a is bearing against the yoke 301 and straddles the first air gap 309a.

Similarly, when the second air gap 309b is short-circuited by the second element 310b, said element 310b is bearing against the yoke 301 and straddles the second air gap 309b (FIG. 5).

It is understood, without it being necessary to specify it, that the first magnet 307a and the first element 310a are facing each other through the first air gap 309a, and that the second magnet 307b and the second element 310b are facing each other through the second air gap 309b.

Advantageously, the first air gap 309a and the second air gap 309b are arranged at the level of the secondary section 303a. In particular, the secondary section 303a is rectilinear and parallel to the elongation axis XX′.

Advantageously, the first magnetic polarity and the second magnetic polarity are parallel to the elongation axis XX′, and in opposition to each other.

According to one or the other of the first and second alternatives, the converter 100 may also comprise a first magnet short-circuit 311a and a second magnet short-circuit 311b, named hereafter, respectively, first short-circuit 311a and second short-circuit 311b (FIG. 4b).

The first short-circuit 311a and the second short-circuit 311b are integral with the yoke 301.

“Integral with the yoke” is taken to mean connected to the yoke by a fixed link (or an embedding link).

The first short-circuit 311a and the second short-circuit 311b are intended to short-circuit the field lines, respectively, of the first magnet 307a and of the second magnet 307b as soon as the yoke 301 finds itself in the second equilibrium position P2 or in the first equilibrium position P1.

“Short-circuiting the field lines of a magnet” is taken to mean establishing a magnetic path in which the field lines generated by a magnet are guided. In other words, the field lines are, at least in part, turned away from the yoke.

Advantageously, the first short-circuit 311a and the second short-circuit 311b each comprise a plate, made of a ferromagnetic material, and laid out to connect the two poles, respectively, of the first magnet and of the second magnet, as soon as the yoke finds itself in the second equilibrium position P2 or in the first equilibrium position P1.

The first short-circuit 311a and the second short-circuit 311b may be fixedly connected to the yoke 301, respectively, by first uprights 312a and second uprights 312b (FIG. 4b).

Such an electromagnetic energy converter 100 as soon as it is at rest finds itself in one or the other of the two equilibrium positions stabilised by the first magnet 307a or the second magnet 307b. It may in particular be stabilised in its first equilibrium position P1 by the first magnet 307a, such that a magnetic flux passes through the conductive coil along the first direction S1. An external force exerted on the yoke 301, more particularly at the level of the secondary portion 303, makes it possible to cause the rotation of the yoke 301, around its axis of rotation X1X1′, from the first equilibrium position P1 to the second equilibrium position P2 (the yoke 301 thus carries out a direct cycle). During this rotation, there is inversion of the magnetic flux passing through the conductive coil, and consequently, appearance of an electrical voltage at the terminals of the latter.

Furthermore, the rotation is all the more sudden when each of the first 307a and second 307b magnets exerts an attractive force on the yoke 301. The arrangement of the first 307a and second 307b magnets with respect to the air gap or to the air gaps thus confers on the electromagnetic energy converter 100 a bi-stable character. This effect is particularly advantageous as soon as the electrical voltage generated at the terminals of the conductive coil is as high as this rotation is rapid (as dictated by Lenz's law). It is thereby possible according to this layout to generate an appreciable electrical voltage at the terminals of the conductive coil 200.

Still according to this first embodiment, the converter 100 may comprise at least one side tongue 313 (FIGS. 2 and 6). The at least one side tongue 313 is laid out to cause the passage of the yoke 301 from its first equilibrium position P1 to its second equilibrium position P2 as soon as an external force is applied to said tongue.

In particular, the at least one side tongue 313 may extend along a direction radial to the axis of rotation X1-X1′ from the secondary section 303a.

Advantageously, the at least one side tongue 313 may be adapted to bend under the action of an external force intended to cause the rotation of the yoke 301 according to a direct cycle. In particular, the at least one tongue 313 may be a spring clip.

Thus, the at least one side tongue 313, when it is subjected to an external force, bends in a first phase and accumulates mechanical energy. As soon as the mechanical energy accumulated by the tongue increases to a point such that the equilibrium position in which the yoke 301 finds itself is no longer tenable, said yoke 301 pivots around its axis of rotation X1X1′ to adopt the other equilibrium position.

During this rotation, the tongue 313 releases an energy which has the effect of accelerating the rotation of the yoke 301, and consequently making it possible to reach an electrical voltage even higher at the terminals of the conductive coil.

The converter may also be provided with a return means 314 (FIGS. 4a and 4c) adapted to force the yoke 301 to adopt the first equilibrium position P1 as soon as no external force is applied to said yoke.

The return means 314 may be for example a spring.

Said return means 314 is particularly advantageous because it makes it possible, when the electromagnetic energy converter is activated, to double the temporal variation in magnetic flux passing through the conductive coil.

Indeed, as soon as an external mechanical action acts on the yoke 301, or on the side tongue 313, the yoke carries out a direct cycle. This direct cycle, after relaxation of the external mechanical action, is immediately followed by an indirect cycle by action of the return means 314 on the yoke 301.

In a particularly advantageous manner, the electromagnetic energy converter may comprise limit stops intended to prevent the rotation of the yoke 301 beyond the first position P1 and the second position P2.

The magnets, potentially associated with ferromagnetic parts, may ensure this stop role; which ensures, once in stop position, good conduction of the magnetic flux (no residual space).

FIGS. 6, 7a, 7b, 7c, 8a, 8b, and 8c illustrate a second embodiment of the present invention.

According to this second embodiment the at least one magnetic flux variation device comprises two magnetic flux variation devices described in the first embodiment of the present invention.

The two magnetic flux variation devices are called, respectively, first magnetic flux variation device 300a and second magnetic flux variation device 300b.

The yokes of each of the first magnetic flux variation device 300a and second magnetic flux variation device 300b are called, respectively, first yoke 301a and second yoke 301b, are laid out to pivot in a simultaneous and symmetrical manner, one from the other, with respect to a plane passing through the elongation axis XX′, around their respective axes of rotation X1a-X1a′ and X1b-X1b′, as soon as an external force is exerted on one or the other of the two yokes.

“Pivot in a simultaneous and symmetrical manner” is taken to mean that the two yokes have the same angular displacement θ at each instant.

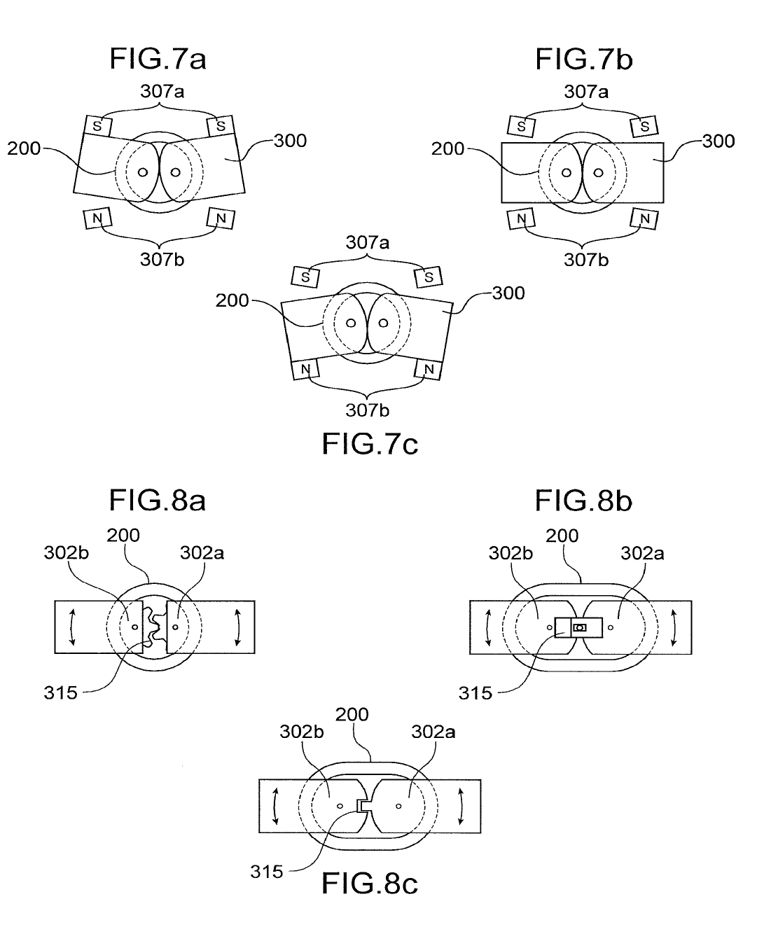

It is also understood without it being necessary to specify it that the first magnet and the second magnet of the first device 300a are placed symmetrically, respectively, to the first magnet and to second magnet of the second device 300b with respect to a plane passing through the elongation axis XX′ (FIGS. 7a to 7c).

Moreover, it is also understood, without it being necessary to specify it, that as soon as the first yoke 301a is coupled to the first magnet of the first device 300a, the second yoke 301b is coupled to the first magnet of the second device 300b (FIG. 7a).

Conversely, as soon as the first yoke 301a is coupled to the second magnet of the first device 300a, the second yoke 301b is coupled to the second magnet of the second device 300b (FIG. 7c).

Furthermore, the main sections of the first yoke 301a and second yoke 301b called, respectively, first main section 302a and second main section 302b, cooperate with each other, via cooperation means 315, so as to enable said yokes to pivot in a simultaneous manner around their respective axes of rotation as soon as an external force is exerted on one or the other of the two yokes (FIGS. 8a to 8c).

The cooperation means 315 may comprise a gearing formed on each of the first 302a and second 302b main sections (FIG. 8a).

Alternatively, the cooperation means 315 comprise a groove formed on one of the first 302a or second 302b main sections, and a profile formed on the other of the first 302a or second 302b main sections, the profile being lodged in the groove (FIG. 8c).

“Profile” is taken to mean a structure projecting with respect to a surface, and intended to cooperate with the groove so as to transmit a mechanical effort from one of the two yokes to the other yoke.

Still alternatively, the cooperation means 315 may be formed by two slides each formed on the first main section 302a and the second main section 302b (FIG. 8b).

Advantageously, the axes of rotation of the first yoke 301a and of the second yoke 301b may be merged with the elongation axis XX′.

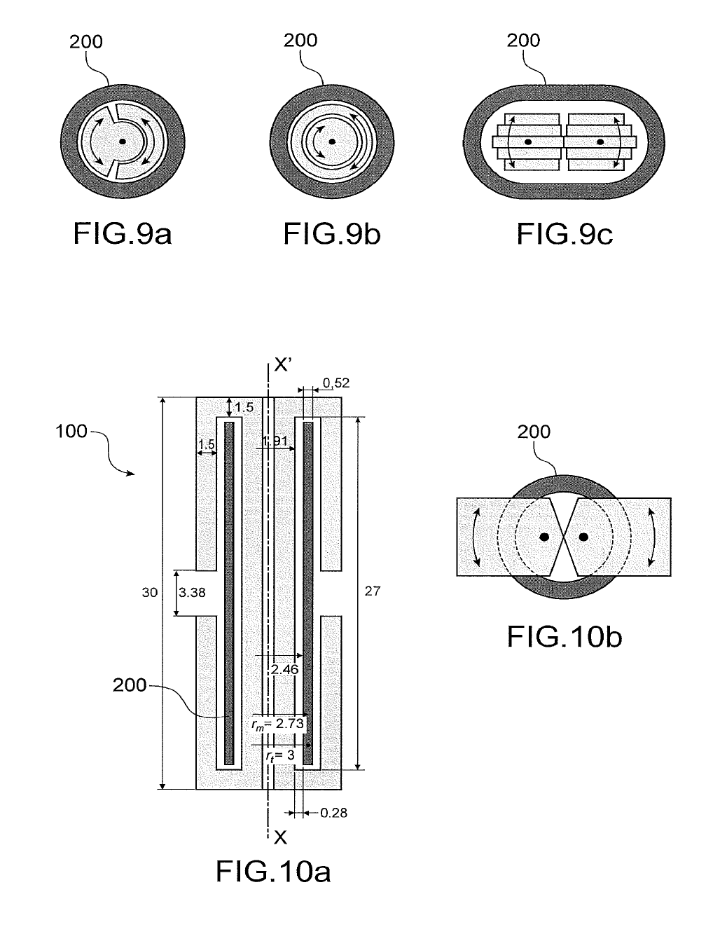

In particular, the first main section 302a and the second main section 302b may form a pivot link between the first yoke 301a and the second yoke 301b (FIGS. 9a and 9b).

According to this second embodiment, the sum of the cross-sectional areas of the first 302a and second 302b main sections may be equal to the sum of the cross-sectional areas of the first 303a1 and second 303b1 secondary sections.

Thus, according to this layout comprising two magnetic flux variation devices, it is possible to double the temporal variation in magnetic flux passing through the conductive coil by applying an external force on uniquely one of the two devices.

An electromagnetic energy converter only comprising a single one of these two magnetic flux variation devices, to generate the same voltage at the terminals of the conductive coil, would have to have a cross-section two times greater, and consequently a greater volume.

Furthermore, the rapid switchover from one equilibrium position to the other of a yoke 301a or 301b may lead to intense angular shocks on the limit stops.

According to the layout proposed in the present invention, the rapid decelerations of the first yoke and of the second yoke, when said yokes collide with the stops, are angularly opposed. The support 110, which is subjected to the sum of the two deceleration torques, is then subjected to a very moderate residual torque. The fixation to the support 110 does not then need to be as robust as a converter only implementing a single magnetic flux variation device. Furthermore, still according to this layout comprising two magnetic flux variation devices, the vibrations associated with the movement of two devices are reduced with respect to a system that only comprises a single device.

This layout with two magnetic flux variation devices also results in a reduction in the moment of inertia by comparison with an electromagnetic energy converter only comprising a single of the two devices and capable of producing the same electrical voltage at the terminals of the conductive coil. This reduction in the moment of inertia makes it possible, for a same torque, to obtain a greater angular acceleration and thus a faster variation in magnetic flux in the coils.

In view of the symmetry of the structure, the effort of placing the two yokes in movement may be provided by one or the other of said yokes.

The return means 314 may comprise a spring of which each of the ends is attached to one of the two yokes. It is furthermore laid out to force each of the two yokes to adapt the first equilibrium position (FIG. 6).

FIGS. 10a and 10b represent an electromagnetic energy converter 100 according to the second embodiment of the present invention.

In these figures, the dimensions are expressed in millimetres. The magnetic fields generated by the two magnets are 0.8 T. The conductive coil is made of a winding of copper wire comprising N=436 turns, and has an electrical resistance of 5.9 Ohms. With this converter, the passage from the first position to the second position takes place in 2 milliseconds.

Such a device makes it possible to produce an energy of 1 mJ.

The present invention also relates to a switch, for example an autonomous switch, comprising the electromagnetic energy converter according to the present invention.

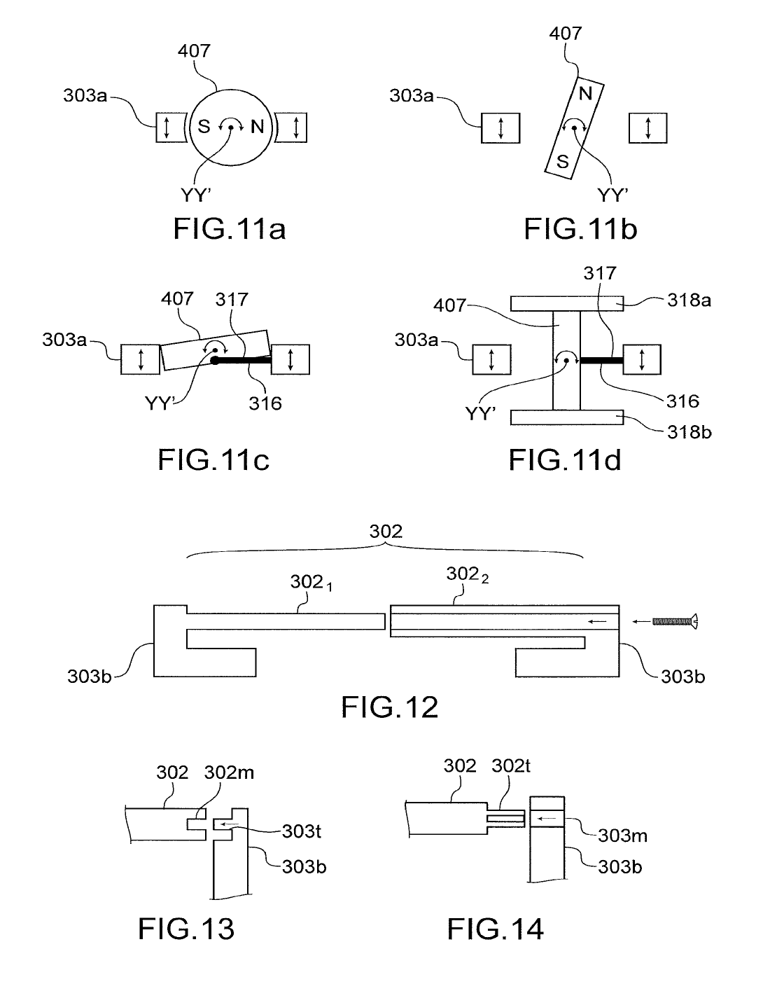

FIGS. 11a to 11d illustrate a third embodiment of the present invention essentially reproducing the elements of the first embodiment.

This third embodiment differs however from the first embodiment in that the magnetic flux variation device only comprises a single magnet 407.

In particular, the secondary portion is provided with the air gap 308 in which the magnet 407 is lodged.

The magnet 407 is laid out to pivot around a pivot axis YY′ between two pivot positions called, respectively, first pivot position and second pivot position.

The at least one magnetic flux variation device 300 further comprises a drive mechanism 316 laid out to force the magnet 407 to adopt the first pivot position or the second pivot position as soon as the yoke finds itself, respectively, in the first position P1 or the second position P2.

Furthermore, the polarisation of the magnet 407 is laid out such that when the yoke 301 is in its first position P1, the magnetic flux guided by said yoke 301 passes through the conductive coil 200 in a first direction S1, and when the yoke 301 is in its second equilibrium position P2, the magnetic flux guided by said yoke 301 passes through the conductive coil 200 in a second direction S2 opposite to the first direction S1.

In other words, the passage from one equilibrium position to the other of the yoke 301 makes the magnet 407 pivot, via a drive mechanism 316, from one pivot position to the other pivot position.

In particular, during a direct cycle, the magnet 407 pivots from its first pivot position to its second pivot position.

Conversely, during an indirect cycle, the magnet 407 pivots from its second pivot position to its first pivot position.

It is understood, without it being necessary to specify it, that the rotation of the magnet is induced by the movement or the rotation of the yoke via the drive mechanism 316.

Thus, as soon as the yoke 301 carries out a direct cycle and/or an indirect cycle, the magnetic flux passing through the conductive coil 200 varies such that an electrical voltage appears at its terminals.

The drive mechanism may advantageously comprise a fixed rack, cooperating with a gearing integral with the magnet.

In particular, the rack is fixed to the support 110, and cooperates with the gearing fixed on the magnet. Advantageously, the gearing is centred with respect to the pivot axis YY′.

This configuration is particularly advantageous since it enables a complete turnaround (of 180°) of the magnet 407 if the latter has a symmetry of revolution with respect to the pivot axis YY′.

Alternatively, the drive mechanism 316 may comprise a leg 317 fixedly maintained, along one of its ends, to the yoke at the level of the air gap, and intended to make the magnet pivot from one of its pivot positions to the other of its pivot positions as soon as the yoke pivots from one of its equilibrium positions to the other of its equilibrium positions (FIGS. 11c and 11d).

The leg 317 also comprises another end which may be connected to the magnet 407 by a pivot link, said pivot link being offset from the pivot axis YY′.

In a particularly advantageous manner, the magnet 407 has a symmetry of revolution around the pivot axis YY′. The air gap 308 may then be of complementary shape to the magnet 407. According to this configuration, the magnet 407 is advantageously maintained by a pivot link in the air gap 308.

The magnet 407 may also have a parallelepiped shape. According to this configuration, the pivot axis can pass through the centre of the magnet 407, and pass through on either side, in a perpendicular manner, two opposite faces of said magnet 407. In a particularly advantageous manner, the pivot axis is also perpendicular to the magnetic polarisation of the magnet 407.

The magnet 407, as soon as it has a parallelepiped shape, may comprise two ends in alignment with the direction defined by its poles (parallel to the magnetic polarisation of the magnet), and at the level of which are arranged first 318a and second 318b ferromagnetic plates and intended to prevent any contact between the yoke 301 and the magnet 407. This layout makes it possible to limit shocks between the magnet 407 and the yoke 301 and consequently to reduce its wear.

According to a fourth embodiment of the present invention, the at least one magnetic flux variation device 300 comprises two magnetic flux variation devices.

This embodiment essentially reproduces the layout described in the second embodiment but implements two magnetic flux variation devices described in the third embodiment.

FIGS. 16a and 16b illustrate a fifth embodiment of the present invention essentially reproducing the elements of the first embodiment.

This fifth embodiment differs however from the first embodiment in that the magnetic flux variation device only comprises a single magnet 607.

In particular, the secondary portion of the yoke is provided with an air gap 308 in which the magnet 607 is lodged. The air gap 308 is formed by a volume delimited by two terminations of the yoke called, respectively, first termination and second termination. In other words, the magnet 607 is arranged between the two terminations of the yoke 301.

The magnet 607 is fixed, and may for example extend, from its first end to its second end, in a radial manner with respect to the axis X1-X1′ of rotation of the yoke. In particular, the magnet 607 may finds itself in the median plane PM.

The two ends of the magnet may be in alignment with the direction defined by its poles.

The magnet 607 also comprises two branches, made of a ferromagnetic material, called, respectively, first branch 701 and second branch 702, and arranged, respectively, at the level of the first end and of the second end. Each of the two branches comprises two sub-branches.

The two sub-branches of a given branch are laid out such that one of the sub-branches contacts the yoke at the level of one of its terminations as soon as the yoke finds itself in one of its equilibrium positions, whereas the other sub-branch contacts the yoke at the level of the other termination as soon as the yoke finds itself in its other equilibrium position.

The contact of a sub-branch, of a given branch, at the level of a termination, magnetically connects said termination with the end of the magnet on which is arranged said branch.

More particularly, the branches are laid out such that each of the two terminations of the yoke, as soon as the yoke is in one of its two equilibrium positions, is in contact with, respectively, a sub-branch of the first branch, and a sub-branch of the second branch.

In other words, the sub-branches of the two branches are thus laid out such that as soon as the yoke 301 finds itself in one of its equilibrium positions, a magnetic contact between the first end of the magnet with one of the two terminations of the yoke 301, and a magnetic contact between the second end of the magnet with the other of the two terminations of the yoke 301 are established. Thus, as soon as the yoke 301 finds itself in an equilibrium position, a magnetic flux imposed by the magnet circulates in the yoke 301.

The two branches may comprise ferromagnetic sheets in torsion.

In particular, the two sub-branches of the first branch, called, respectively, first sub-branch 701a and second sub-branch 701b, connect respectively, the first termination of the yoke 301 as soon as said yoke 301 finds itself in its first equilibrium position, and the second termination of the yoke 301 as soon as said yoke 301 finds itself in its second equilibrium position.

In an equivalent manner, the two sub-branches of the second branch, called, respectively, third sub-branch 702a and fourth sub-branch 702b, connect, respectively, the first termination of the yoke 301 as soon as said yoke 301 finds itself in its first equilibrium position, and the second termination of the yoke 301 as soon as said yoke 301 finds itself in its second equilibrium position.

Thus, a direct cycle or an indirect cycle generates a variation in flux in the conductive coil 200.

According to a sixth embodiment of the present invention, the at least one magnetic flux variation device 300 comprises two magnetic flux variation devices.

This embodiment essentially reproduces the layout described in the second embodiment but implements the two magnetic flux variation devices described in the fifth embodiment.

The present invention also relates to a switch, for example an autonomous switch comprising the electromagnetic energy converter according to the present invention.

Each of the at least one side tongues may be associated with a button and/or a particular functionality of the switch.

The implementation of an electromagnetic energy converter according to any one of the 6 embodiments makes it possible to produce autonomous switches of small size and more robust compared to switches known from the prior art.

The electromagnetic energy converter may also be implemented in commands, limit sensors, opening detectors, and other mechanically actuated autonomous detectors.

In most cases, the recovered energy will serve in part in transmitting radio information to a remote wireless receiver, information giving for example the state of the switches/sensors/detectors. However, other applications may be envisaged, such as for example the counting of events, with a recording in a memory and which does not necessarily communicate at each mechanical pressure.

Whatever the embodiment considered, the yoke or the yokes may be dismountable.

According to a first example illustrated in FIG. 12, the dismountable yoke 301 comprises two elements capable of being connected together by a screw. According to this example, the main section 302 is in fact a shaft 302₁ and a tube 302₂ which comprises a drilling hole intended to cooperate with the shaft 302₁. In particular, the shaft 302₁ is fixedly connected to one of the side sections 303b, whereas the tube 302₂ is fixedly connected to the other of the side sections 303c.

Alternatively, as illustrated in FIG. 13, the main section 302 may be single-piece, and comprises at each of these ends a mortise 302m intended to receive a tenon 303t arranged on one or the other of the side sections 303b, 303c. The section 302 may form a single-piece part with one of the side sections 303c positioned along one of the ends of said section 303b. The other end of the section 300b may be connected in a non-permanent manner to the other side section 303b by the combination of the mortise and the tenon.

Still alternatively, and as illustrated in FIG. 14, the main section 302 may be single-piece, and comprise at each of these ends a tenon 302t intended to be received by a mortise 303m arranged on one or the other of the side sections 303b, 303c. The section 302 may form a one-piece part with one of the side sections 303c positioned along one of the ends of said section 303b. The other end of the section 300b may be connected in a non-permanent manner to the other side section 303b by the combination of the mortise and the tenon.

The mortises 302m and 303m may be round, cross-shaped, or have any other shape capable of suiting the targeted application.

This layout then makes it possible to thread a conductive coil formed before the mounting of the yoke or the yokes.

The yokes may also be non-dismountable. The conductive coil may then be formed by passing the conductive wire via the air gaps during the winding of the turns.

A coil support, which can next be removed or dissolved, may be necessary to avoid a placing in contact of the turns with the yoke or the yokes during the production of the windings. Indeed, this contact could restrict or even block the rotation of the yoke. The coil may be impregnated with adhesive in order that it conserves its shape.

### REFERENCES

[1] WO 2011/069879 A1

1. Electromagnetic energy converter comprising:
a conductive coil (200) extending along an elongation axis XX′,
at least one magnetic flux variation device (300) which comprises a yoke (301) and two fixed magnets called, respectively, first magnet (307a) and second magnet (307b), the yoke (301) comprising a main section (302) passing through the conductive coil (200), and a secondary portion offset from the conductive coil (200), the yoke (301) being laid out to pivot around a fixed axis of rotation, parallel to the elongation axis XX′, between two stable equilibrium positions called, respectively, first equilibrium position P1 and second equilibrium position P2, the two magnets being laid out such that when the yoke (301) is in its first equilibrium position P1, said yoke (301) is magnetically coupled to the first magnet (307a) so as to make a magnetic flux circulate through the conductive coil (200) in a first direction S1, and when the yoke (301) is in its second equilibrium position P2, said yoke (301) is magnetically coupled to the second magnet (307b) so as to make a magnetic flux circulate through the conductive coil (200) in a second direction S2 opposite to the first direction S1.

2. Converter according to claim 1, in which the secondary portion of the yoke (301) comprises an air gap (308) at the level of which takes place the magnetic coupling of one or the other of the first (307a) and second (307b) magnets with said yoke (301) as soon as the latter finds itself, respectively, in its first equilibrium position P1 or in its second equilibrium position P2.

3. Converter according to claim 2, in which as soon as the yoke (301) is magnetically coupled to one or the other of the two magnets, said magnet is either inserted in the air gap (308), or bearing against the yoke (301) and straddles the air gap (308).

4. Converter according to claim 1, in which the secondary portion of the yoke (301) comprises a first air gap (309a) and a second air gap (309b) at the level of which takes place the magnetic coupling, respectively, of the first magnet (307a) and of the second magnet (307b) with said yoke (301) as soon as the latter finds itself, respectively, in its first equilibrium position P1 or in its second equilibrium position P2.

5. Converter according to claim 4, in which the converter further comprises a first element (310a) and a second element (310b), fixed, made of a ferromagnetic material, and laid out to short-circuit, respectively, the first air gap (309a) and the second air gap (309b) as soon as the yoke (301) finds itself, respectively, in its second equilibrium position P2 or in its first equilibrium position P1.

6. Converter according to claim 1, in which the first magnet (307a) and the second magnet (307b) have, respectively, a first magnetic polarity and a second magnetic polarity, the first and the second magnetic polarity being parallel and in opposition one from the other, advantageously, the first magnetic polarity is parallel to the elongation axis XX′.

7. Converter according to claim 1, in which the converter further comprises at least one side tongue (313) laid out to cause the passage of the yoke (301) from its first equilibrium position P1 to its second equilibrium position as soon as an external force is applied to said tongue.

8. Converter, according to claim 7, in which the side tongue (313) is adapted to bend under the action of an external force and to accumulate a mechanical energy before the yoke (301) passes from its first equilibrium position P1 to its second equilibrium position P2, said mechanical energy accumulated by the side tongue (313) is released during the passage of the yoke (301) from its first equilibrium position P1 to its second P2 equilibrium position.

9. Converter according to claim 1, in which the at least one magnetic flux variation device (300) comprises two magnetic flux variation devices called, respectively, first magnetic flux variation device (300a) and second magnetic flux variation device (300b), the yokes (301) of each of the first magnetic flux variation device (300a) and second magnetic flux variation device (300b), called respectively, first yoke (301a) and second yoke (301b), are laid out to pivot in a simultaneous and symmetrical manner one from the other with respect to a plane passing through the elongation axis XX′, around their respective axes of rotation, as soon as an external force is exerted on one or the other of the two yokes (301).

10. Converter according to claim 9, in which the main sections of the first yoke (301a) and second yoke (301b) called, respectively, first main section (302a) and second main section (302b), cooperate with each other, via cooperation means (315), so as to enable said yokes (301) to pivot in a simultaneous manner around their respective axes of rotation, as soon as an external force is exerted on one or the other of the two yokes (301).

11. Electromagnetic energy converter (100) comprising:
a conductive coil (200) extending along an elongation axis XX′,
at least one magnetic flux variation device (300) which comprises a yoke (301) provided with a main section (302) passing through the conductive coil (200), and a secondary portion provided with an air gap and offset from the conductive coil (200), the yoke (301) being laid out to pivot around a fixed axis of rotation, parallel to the elongation axis XX′, between two stable equilibrium positions called, respectively, first equilibrium position P1 and second equilibrium position P2, said yoke (301) being intended to guide a magnetic flux generated by a magnet (407) lodged in the air gap, said magnet (407) is laid out to pivot around a pivot axis between two pivot positions called, respectively, first pivot position and second pivot position, the at least one magnetic flux variation device (300) further comprises a drive mechanism (316) laid out to force the magnet (407) to adopt the first pivot position or the second pivot position as soon as the yoke (301) finds itself, respectively, in the first position P1 or the second position P2, and such that when the yoke (301) is in its first position P1, the magnetic flux is guided by said yoke (301) through the conductive coil (200) in a first direction S1, and when the yoke (301) is in its second equilibrium position P2, the magnetic flux is guided by said yoke (301) through the conductive coil (200) in a second direction S2 opposite to the first direction S1.

12. Converter according to claim 11, in which the magnet (407) has a parallelepiped shape.

13. Converter according to claim 12, in which the magnet (407) comprises two ends in alignment with the direction defined by its poles, and at the level of which are arranged a first (318a) and a second (318b) ferromagnetic plate and intended to prevent any contact between the yoke (301) and the magnet.

14. Converter according to claim 11, in which the secondary portion comprises a straight secondary section, parallel to the elongation axis XX′, and at the level of which is arranged the air gap.

15. Converter according to claim 11, in which the converter further comprises at least one side tongue (313) laid out to cause the passage of the yoke (301) from its first equilibrium position P1 to its second equilibrium position as soon as an external force is applied to said tongue.

16. Converter according to claim 11, in which the at least one magnetic flux variation device (300) comprises two magnetic flux variation devices called, respectively, first magnetic flux variation device (300a) and second magnetic flux variation device (300b), the yokes of each of the first magnetic flux variation device and second magnetic flux variation device called, respectively, first yoke (301a) and second yoke (301b), are laid out to pivot in a simultaneous and symmetrical manner, one from the other, with respect to a plane passing through the elongation axis XX′, around their respective axes of rotation, as soon as an external force is exerted on one or the other of the two yokes.

17. Converter according to claim 16, in which the main sections of the first yoke and second yoke called, respectively, first main section (302a) and second main section (302b), cooperate with each other, via cooperation means, so as to enable said yokes to pivot in a simultaneous manner around their respective axes of rotation as soon as an external force is exerted on one or the other of the two yokes.

18. Electromagnetic energy converter (100) comprising:
a conductive coil (200) extending along an elongation axis XX′,
at least one magnetic flux variation device (300) which comprises a yoke (301) provided with a main section (302) passing through the conductive coil (200), and a secondary portion provided with an air gap and offset from the conductive coil (200), the yoke (301) being laid out to pivot around a fixed axis of rotation, parallel to the elongation axis XX′, between two stable equilibrium positions called, respectively, first equilibrium position P1 and second equilibrium position P2, said yoke (301) being intended to guide a magnetic flux generated by a magnet (607) lodged in the air gap, the air gap being delimited by two terminations of the yoke, called respectively first termination and second termination, the magnet (607) also comprises two branches, made of a ferromagnetic material, called, respectively, first branch (701) and second branch (702), and arranged, respectively, at the level of a first end and a second end of said magnet, each of the two branches comprises two sub-branches, the branches are laid out such that each of the two terminations of the yoke, as soon as the yoke is in one of its two equilibrium positions, is in contact with, respectively, a sub-branch of the first branch, and a sub-branch of the second branch, and such that when the yoke (301) is in its first position P1, the magnetic flux is guided by said yoke (301) through the conductive coil (200) in a first direction S1, and when the yoke (301) is in its second equilibrium position P2, the magnetic flux is guided by said yoke (301) through the conductive coil (200) in a second direction S2 opposite to the first direction S1.

19. Autonomous switch comprising the electromagnetic energy converter according to claim 1.

20. Autonomous switch comprising the electromagnetic energy converter according to claim 11.
